(19) United States
(12) Patent Application Publication
(10) Pub. No.: US 2025/0086499 A1
(43) Pub. Date: Mar. 13, 2025

(54) SYSTEMS AND METHODS FOR MODELING OF OMNICHANNEL DATA

(71) Applicant: JPMORGAN CHASE BANK, N.A., New York, NY (US)

(72) Inventors: Anjana UMAPATHY, Santa Clara, CA (US); Venkata H. RAO, Great Neck Plaza, NY (US); Ken HUM, Arlington, TX (US); Abhik BANERJEE, Milpitas, CA (US); Amol MAVUDURU, Richardson, TX (US); Sriharsha PRASAD, The Colony, TX (US); Keshav JAISWAL, Addison, TX (US); Chuanliang JIANG, San Antonio, TX (US); RamPrasad SEELAM, Frisco, TX (US)

(21) Appl. No.: 18/464,905

(22) Filed: Sep. 11, 2023

(51) Int. Cl. G06N 20/00

(52) U.S. Cl. CPC G06N 20/00

(57) ABSTRACT

In some aspects, the techniques described herein relate to a method including: receiving, from a plurality of data channels, client interaction data; preprocessing the client interaction data into a format consumable by one or more machine learning models; ingesting, by a sentiment scorer machine learning model, the client interaction data; generating, by the sentiment scorer machine learning model, a plurality of sentiment scores for a client associated with the client interaction data; ingesting, by a health scorer machine learning model, the plurality of sentiment scores; and outputting, by the health scorer machine learning model and based on the plurality of sentiment scores, a weighted health index score for the client associated with the client interaction data.

### BACKGROUND

### 1. Field of The Invention

Aspects generally relate to systems and methods for modeling of omnichannel data.

### 2. Description of the Related Art

Modern service organizations collect voluminous client data from a multitude of data channels. Data collected from each of these channels may provide useful information to the collecting organization. The collected data, however, must be thoughtfully processed in order to extract the relevant information contained therein.

### SUMMARY

In some aspects, the techniques described herein relate to a method including: receiving, from a plurality of data channels, client interaction data; preprocessing the client interaction data into a format consumable by one or more machine learning models; ingesting, by a sentiment scorer machine learning model, the client interaction data; generating, by the sentiment scorer machine learning model, a plurality of sentiment scores for a client associated with the client interaction data; ingesting, by a health scorer machine learning model, the plurality of sentiment scores; and outputting, by the health scorer machine learning model and based on the plurality of sentiment scores, a weighted health index score for the client associated with the client interaction data.

In some aspects, the techniques described herein relate to a method, including: Ingesting, by the health scorer machine learning model, a data channel identifier for each sentiment score of the plurality of sentiment scores, wherein the data channel identifier indicates a data channel from which sentiment data that a corresponding one of the plurality of sentiment scores is based on was received.

In some aspects, the techniques described herein relate to a method, including: Ingesting, by the health scorer machine learning model, an age for each sentiment score of the plurality of sentiment scores, wherein the age indicates a time when the sentiment data that a corresponding one of the plurality of sentiment scores is based on was collected.

In some aspects, the techniques described herein relate to a method, including: providing, for each data channel identifier, a legitimacy score, wherein the legitimacy score indicates a weight assigned to the data channel identifier.

In some aspects, the techniques described herein relate to a method, including: providing a plurality of age weights, wherein each of the plurality of age weights corresponds to a corresponding age window of a plurality of age windows.

In some aspects, the techniques described herein relate to a method, wherein the age for each sentiment score of the plurality of sentiment scores falls into one of the plurality of age windows, and wherein the age for each sentiment score of the plurality of sentiment scores is assigned an age weight that corresponds to the corresponding age window into which each sentiment score of the plurality of sentiment scores falls.

In some aspects, the techniques described herein relate to a method, including: weighting, by the health scorer machine learning model, the weighted health index score based on the age weight that corresponds to the corresponding age window into which each sentiment score of the plurality of sentiment scores falls and the legitimacy score for each data channel identifier for each sentiment score of the plurality of sentiment scores.

In some aspects, the techniques described herein relate to a system including at least one computer including a processor, wherein the at least one computer is configured to: receive, from a plurality of data channels, client interaction data; preprocess the client interaction data into a format consumable by one or more machine learning models; ingest, by a sentiment scorer machine learning model, the client interaction data; generate, by the sentiment scorer machine learning model, a plurality of sentiment scores for a client associated with the client interaction data; ingest, by a health scorer machine learning model, the plurality of sentiment scores; and output, by the health scorer machine learning model and based on the plurality of sentiment scores, a weighted health index score for the client associated with the client interaction data.

In some aspects, the techniques described herein relate to a system, wherein the at least one computer is configured to: Ingest, by the health scorer machine learning model, a data channel identifier for each sentiment score of the plurality of sentiment scores, wherein the data channel identifier indicates a data channel from which sentiment data that a corresponding one of the plurality of sentiment scores is based on was received.

In some aspects, the techniques described herein relate to a system, wherein the at least one computer is configured to: Ingest, by the health scorer machine learning model, an age for each sentiment score of the plurality of sentiment scores, wherein the age indicates a time when the sentiment data that a corresponding one of the plurality of sentiment scores is based on was collected.

In some aspects, the techniques described herein relate to a system, wherein the at least one computer is configured to: provide, for each data channel identifier, a legitimacy score, wherein the legitimacy score indicates a weight assigned to the data channel identifier.

In some aspects, the techniques described herein relate to a system, wherein the at least one computer is configured to: provide a plurality of age weights, wherein each of the plurality of age weights corresponds to a corresponding age window of a plurality of age windows.

In some aspects, the techniques described herein relate to a system, wherein the age for each sentiment score of the plurality of sentiment scores falls into one of the plurality of age windows, and wherein the age for each sentiment score of the plurality of sentiment scores is assigned an age weight that corresponds to the corresponding age window into which each sentiment score of the plurality of sentiment scores falls.

In some aspects, the techniques described herein relate to a system, wherein the at least one computer is configured to: weight, by the health scorer machine learning model, the weighted health index score based on the age weight that corresponds to the corresponding age window into which each sentiment score of the plurality of sentiment scores falls and the legitimacy score for each data channel identifier for each sentiment score of the plurality of sentiment scores.

In some aspects, the techniques described herein relate to a non-transitory computer readable storage medium, including instructions stored thereon, which instructions, when read and executed by one or more computer processors, cause the one or more computer processors to perform steps including: receiving, from a plurality of data channels, client interaction data; preprocessing the client interaction data into a format consumable by one or more machine learning models; ingesting, by a sentiment scorer machine learning model, the client interaction data; generating, by the sentiment scorer machine learning model, a plurality of sentiment scores for a client associated with the client interaction data; ingesting, by a health scorer machine learning model, the plurality of sentiment scores; and outputting, by the health scorer machine learning model and based on the plurality of sentiment scores, a weighted health index score for the client associated with the client interaction data.

In some aspects, the techniques described herein relate to a non-transitory computer readable storage medium, including: ingesting by the health scorer machine learning model a data channel identifier for each sentiment score of the plurality of sentiment scores, wherein the data channel identifier indicates a data channel from which sentiment data that a corresponding one of the plurality of sentiment scores is based on was received.

In some aspects, the techniques described herein relate to a non-transitory computer readable storage medium, including: ingesting by the health scorer machine learning model an age for each sentiment score of the plurality of sentiment scores, wherein the age indicates a time when the sentiment data that a corresponding one of the plurality of sentiment scores is based on was collected.

In some aspects, the techniques described herein relate to a non-transitory computer readable storage medium, including: providing, for each data channel identifier, a legitimacy score, wherein the legitimacy score indicates a weight assigned to the data channel identifier.

In some aspects, the techniques described herein relate to a non-transitory computer readable storage medium, including: providing a plurality of age weights, wherein each of the plurality of age weights corresponds to a corresponding age window of a plurality of age windows.

In some aspects, the techniques described herein relate to a non-transitory computer readable storage medium, wherein the age for each sentiment score of the plurality of sentiment scores falls into one of the plurality of age windows, and wherein the age for each sentiment score of the plurality of sentiment scores is assigned an age weight that corresponds to the corresponding age window into which each sentiment score of the plurality of sentiment scores falls, and including: weighting, by the health scorer machine learning model, the weighted health index score based on the age weight that corresponds to the corresponding age window into which each sentiment score of the plurality of sentiment scores falls and the legitimacy score for each data channel identifier for each sentiment score of the plurality of sentiment scores.

### BRIEF DESCRIPTION OF THE DRAWINGS

FIG. 1 is a block diagram of a system for modeling of omnichannel data, in accordance with aspects.

FIG. 2 is a logical flow for modeling of omnichannel data, in accordance with aspects.

FIG. 3 is a block diagram of a computing device for implementing certain aspects of the present disclosure.

### DETAILED DESCRIPTION

Aspects generally relate to systems and methods for modeling of omnichannel data.

Aspects may provide a modeling platform that ingests explicit and implicit client data received through various data channels, performs preprocessing on received data, and provides the preprocessed data to different models within a modeling engine. Output of some models may be persisted and used as input to other models within the modeling engine. Output may further be configured for access via an interface for use by users in client engagement. Output data may be validated by end users and incorporated into a training regiment such that models in the modeling engine are periodically re-trained on validated data.

In accordance with aspects, data may be received from various channels that a client of an implementing organization may utilize to communicate with the implementing organization. Some of the channels may be explicit communication channels, such as telephone communications, electronic mail (email), or real time text-based (commonly known as “chat”) interfaces. Some channels may be implicit communication channels such as usage statistics from a computer application (e.g., a mobile application) provided by an implementing organization or various sources of “clickstream” information that is collected through a client's use of, e.g., an implementing organization's website, provided computer applications, etc.

A client of an implementing organization may be a corporate entity (i.e., a business) that is represented by a human associate of the corporate entity. As used herein, a “client” includes the corporate entity and any human associate or agent of the entity that acts on behalf of the entity (e.g., that undertakes an interaction or communication through a data channel on behalf of the corporate entity).

Data collected form various data channels may be persisted to a datastore such as a data lake. Data may be persisted in its native format and may be provided to various preprocessing computer programs/modules that may structure and/or format data for ingestion by one or more machine learning models of a modeling engine. A preprocessing engine may persist data preprocessed for ingestion by a modeling engine back to a data lake. A modeling engine may access the preprocessed data, ingest the data as input and output predictions based on the input data. Some models may take other models' output as input (i.e., some models may have a dependency on the out of other models). A modeling engine may provide output of machine learning (ML) models contained therein to an interface accessible to organizational users, and the interface may provide the data in a structured and consumable format.

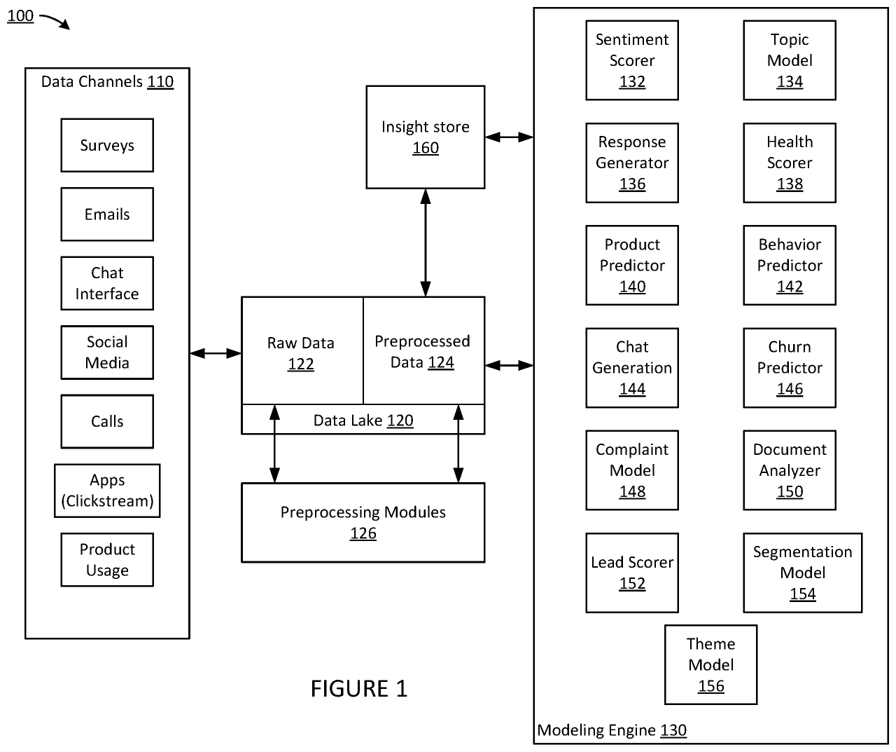

FIG. 1 is a block diagram of a system for modeling of omnichannel data, in accordance with aspects. Framework 100 includes data channels 110, data lake 120, preprocessing modules 126, and modeling engine 130. Data lake 120 may be logically divided into raw data 122, which may be storage for native or raw data received from data channels 110 and preprocessed data 124, which may be storage for data that is preprocessed by preprocessing modules 126. Data lake 120 may be one or more physical or logical datastores.

Data lake 120 may be a data lake or a similarly configured datastore. In accordance with aspects, a data lake is a datastore configured to store large amounts of data in its native, raw (i.e., untransformed) format. Data may be stored in a structured, semi-structured, or unstructured state. A data lake may be configured with a flat storage architecture (as opposed to a hierarchical structure of some other types of datastores) and may utilize object storage for storing different types of data. A data object (e.g., a file of any particular type) may be stored in a data lake along with associated metadata tags that describe the stored object. Additionally, each object may have an associated identifier (e.g., a unique identifier (UID) or key). A query of a data lake may retrieve data objects from the data lake using metadata tags, a unique identifier, or both, as parameters of a query.

In accordance with aspects, data lake 120 may receive data in various formats from data channels 110. For instance, data lake 120 may receive data such as survey results, emails, text from a chat interface, text from a social media platform (e.g., posts, comments, etc., associated with an implementing organization's presence or a client's presence on a social media platform), and audio data from recorded telephone calls including an organizational client as a participant of the call (e.g., a call made to a call center of an implementing organization). Moreover, an implementing organization may collect data from applications provided to clients of the organizations, such as product usage statistics and information collected about a client while browsing a website of the organization or while using a web browser configured to collect such information (referred to as “clickstream” data).

Data lake 120 may store data received from data channels 110 in the received data's native format in raw data 122, which is a logical or physical partition of data lake 120. Preprocessing modules 126 may access raw data 122 and perform preprocessing procedures on the data stored therein. Preprocessing modules 126 may include various logical processes for preprocessing data included in raw data 122. For instance, each type of data (i.e., data from each of a variety of data channels) may have one or more associated preprocessing operations in order to prepare the data to be consumed by modeling engine 130. For instance, speech modules that are stored as recorded audio may be processed with a speech-to-text operation, and/or a voice detection operation. Textual data stored as image-based documents (e.g., image-based .pdf documents) may be processed with an optical character recognition operation. Text-based documents may undergo a tokenization and vector embedding process. Clickstream data may be stored in a graph format. All data may be processed with a personally identifiable information (PII) masking operation, so that data may be anonymized for use with modeling engine 130. Other data preprocessing may be executed as is necessary or desired.

In accordance with aspects, data stored in raw data 122 and/or preprocessed data 124 may be stored with a relationship to a client record or profile so that the client that is the source of the collected data can be identified and linked to the data. In some aspects, client information such as client profile information and a unique client identifier (e.g., such as a primary key, etc.) may be stored with associated collected information in data lake 120. In other aspects, a unique client identifier (e.g., such as a primary key, etc.) may be stored in records in data lake 120 (along with data from data channels 110), and other organizational information/data related to an associated client may be queried from other data sources using the unique client identifier as a lookup key.

Preprocessing modules 126 may persist preprocessed data in preprocessed data 124 which is a logical or physical partition of data lake 120. Modeling engine 130 may access preprocessed data 124 and may use data stored in preprocessed data 124 as input data to models included in modeling engine 130.

With continued reference to FIG. 1, modeling engine 130 is configured to store and execute various ML models. ML models stored/executed by modeling engine 130 include sentiment scorer 132, topic model 134, response generator 136, health scorer 138, product predictor 140, behavior predictor 142, chat generator 144, churn predictor 146, complaint model 148, document analyzer 150, lead scorer 152, segmentation model 154, and theme model 156. ML models stored/executed by modeling engine 130 may take data from preprocessed data 124 as input and provide an output based on the input. Output from models of modeling engine 130 may be stored in insight store 160. Insight store 160 may be any suitable datastore for persisting model output.

In accordance with aspects, sentiment scorer 132 may be a sentiment analysis ML model that is configured to predict a client interaction sentiment score for each individual interaction channel that a client of an implementing organization interacts with. Sentiment scorer 132 may take, as input, data from a data channel such as those channels of data channels 110 and a client identifier and may output a sentiment score for a client associated with the received client identifier for each separate data channel received as input. Accordingly, a client may have a sentiment score generated for each data channel that the client interacts with and may have a sentiment score for each interaction with each channel.

Sentiment scorer 132 may be a natural language processing model that is trained on historic sentiment data and output may be a classification of a particular client interaction into one of several sentiment categories (e.g., a favorable sentiment category indicating favorable sentiments of a client towards an implementing organization, an unfavorable sentiment category indicating unfavorable sentiments of a client toward an implementing organization, a neutral sentiment category indicating neutral or undetected sentiments of a client towards an implementing organization, etc.). Input data may include vector embeddings of text from a client interaction through a data channel.

In accordance with aspects, topic model 134 may take textual data (converted in a preprocessing operation, is necessary) from all data channels and from all clients as input and may predict as output, for each interaction, a topic that the interaction is associated with. Topics may be related to an implementing organization's products or services. Additionally processing of output from topic model 134 may identify one or more relatively common topics such that common issues surrounding a common topic may be more easily identified. Topic model 134 may be a natural language processing model that is trained/validated on historic topic data and verified classifications and output may be a classification of a particular client interaction into one of several topic categories.

In accordance with aspects, response generator 136 may be a ML large language model (LLM). Input to response generator 136 may be client communication from any data channel (in text form). Output from response generator 136 may be a response or draft/model response to a client communication received from a data channel. An LLM model of response generator 136 may be trained on a database of internal information about, and internal documentation of, products and services offered by an implementing organization. Accordingly, responses generated by response generator 136 may be generated in the context of internal information about and documentation of products and services offered by an implementing organization.

In accordance with aspects, health scorer 138 may be a machine learning model that is trained and configured to generate a combined, weighted health index score of a client. Input to health scorer 138 may be one or more sentiment scores of a client that is received as output from sentiment scorer 132, a type of data channel, a number of interactions/communications associated with a client, and a history of client index scores. Output may be weighted based on how recent an interaction is and a legitimacy score assigned to a data channel from which the interaction is received. For instance, a legitimacy score may be relatively lower for a social media interaction, communication, post, etc., than for a communication received via an email channel, a telephone call, or a chat interface. Further, a recent interaction may be weighted more heavily than an aged interaction.

An exemplary health index score may be based on one or more client interactions, where a first interaction is a post to a social media account of an implementing organization and a second interaction is a client call to a call center of an implementing organization. The post to the social media account of the implementing organization may be assigned a relatively lower weight due to a data channel identifier received as input that identifies the data channel as a social media channel. Moreover, the post to the social media account may receive a lower weight due to an age of the post (e.g., the relevant social media post may be greater than 6 months old). Consequently, the received social media post may impact a client's health index score relatively less than, e.g., the call by the client to the implementing organization's call center.

The client's call to the call center of the implementing organization, on the other hand, may receive a relatively heavier weighting based on a received data channel identifier that identifies the data channel as a call center. The client call may be weighted still heavier due to the age of the client's call (e.g., one week ago). Accordingly, due to the corresponding channels and ages, the client's call to the call center may be weighted relatively heavier than the client's social media post in an output client health index score of health scorer 138. A client heath index score may be categorized by health scorer 138 into a sliding scale of health categories.

For example, placement of a client into a “green” category may indicate that, based on all of the client's interactions that are included as input to health scorer 138, that the client is generally highly satisfied with an implementing organization's products and/or services that the client uses. Conversely, placement of a client into a “red” category may indicate that, based on all of the client's interactions that are included as input to health scorer 138, that the client is generally unsatisfied with an implementing organization's products and/or services that the client uses. Placement into a “yellow” category may indicate that the client is, e.g., adequately satisfied with products/service.

In accordance with aspects, product predictor 140 may be a machine learning model that takes clickstream data of a client, product usage data of a client, and output from topic model 134 that is associated with a client as input and generates a recommendation of a product or service that is offered by an implementing organization as output. The recommendation may be checked against a list of products or services of the implementing organization that a client already uses, so that recommendations are not superfluously offered to a client.

In accordance with aspects, behavior predictor 142 may be a machine learning model that takes clickstream data and product usage data as input to the model and is configured to output a next step and target state of a client. A next step may be a prediction of an action to take while communicating with a client. A target state of a client may be a prediction of a set of services or products that a client would benefit from.

In accordance with aspects, chat generator 144 is a ML model based on an LLM. Chat generator 144 takes a user query (e.g., a natural language query in text form) from a user interface and outputs a response to the query. Chat generator 144 may be trained on product information and documentation of an implementing organization the same as or similar to response generator 136. Chat generator 144 may be associated with a chat interface data channel and may begin a client's chat session before turning the chat session over to a human agent of an implementing organization.

In accordance with aspects, churn predictor 146 may be a machine learning model that takes, as input, a client's transaction history (which may be stored in and accessible from transaction systems of an implementing organization), a client's sentiment score for each interaction channel that the client interacts with, the client's health index score as output from health scorer 138, and a client segment for a client received as output from, e.g., segmentation model 154 (discussed in more detail, below). Churn predictor 146 may output, based on the input, above, an attrition score that is a score that indicates a likelihood of a client's attrition. For instance, an attrition score may be a sliding scale (e.g., 0.0-1.0) where a score closer to 0 indicates a lower likelihood of attrition, and a score closer to 1 indicates a higher likelihood of attrition.

In accordance with aspects, complaint model 148 may be a ML model that takes client communications/interactions from all data channels (as textual input) and predicts, as output, a complaint included in the user interaction. Complaint model 148 may identify and categorize complaints in client interactions into one of several legal risk categories. Complaints that are categorized into a high legal risk category may be used by an implementing organization to mitigate legal risks associated with complaints and to improve lead time in addressing critical and high legal risk client issues. Output may also be used to derive insights into areas of improvement that an implementing organization may utilize.

In accordance with aspects, document analyzer 150 may be a software module that includes two machine learning models. A first model of document analyzer 150 may be a verification model. A verification model may take a know-your-customer (KYC) document as input and may output a verification of each section of the KYC document and a prediction of a probability that the document has been manipulated or fraudulently completed. A second model may be an analysis model that may also take a KYC document as input and may output extracted information from the document in a predetermined order of relevance.

In accordance with aspects, lead scorer 152 may be a machine learning model that may take client firmographics (e.g., an annual revenue, an industry, a number of employees, etc., of a client business), a sentiment score as output by sentiment scorer 132, Social media activity of a client, and known market trends and economic indicators (e.g., as collected and stored by an implementing institution). Output from lead scorer 152 may be a lead score that indicates the likelihood that a prospect will become a client, a classification of the lead into various predefined categories (e.g., highly likely, somewhat likely, not likely, etc.), and LLM driven suggestions for personalized marketing campaigns and messaging based on the firmographics input. Lead scorer 152 may include more than one machine learning models. For instance, lead scorer 152 may include a LLM that evaluates the input firmographic data, and a classifier model that makes the category predictions.

In accordance with aspects, segmentation model 154 may be a machine learning model that takes firmographic data and product usage data from a client and predicts, as output, a client group that the client logically belongs to and performs assignment of the client to the predicted client group. Clients may be assigned to various predefined groups based on the input such as firmographic data and product usage data.

In accordance with aspects, theme model 156 may perform topic modeling on client interactions within a predefined historic time period. For instance, input to theme model 156 may include all client interactions from all data channels captured in a historic time period (such as the last 6 months). Client interactions may be sorted into health index groups based on health index scores. For instance, a first health index group may include scores that are below a first threshold score but above a bottom (such as a 0 score on a scoring scale of 0-100). A second health index group may include scores above the first threshold score, but below a second threshold score. A third health index group may include scores above the second threshold score and up to a ceiling score (e.g., a 100 score on a scoring scale of 0-100). The first, second, and third health index groups may reflect poor, intermediate, and high sediments (respectively) of the customers' whose corresponding health index scores are categorized therein. Theme model 156 may be provided interactions from clients categorized in one of the health index groups as input to model 156. Output from model 156 may include predictions of “themes” which may include recurring topics that clients in each respective heath index group communicate about. Such topics may then be used to influence changes to products, services, processes, etc.

In accordance with aspects, output from modeling engine 130 may be stored in insight store 160. Output for a given client may be stored with a relation or association (e.g., a lookup key such as a primary/foreign key) to the client's record in insight store 160 or in another database (e.g., a client data base that stores basic client information/profiles/accounts, etc.). Preprocessing modules 126 and/or modeling engine 130 may be configured with a reevaluation trigger that triggers a reevaluation of a client when a new client interaction is received at raw data 122. A reevaluation trigger may trigger any needed preprocessing of received data via any data channel and may trigger a reevaluation by modeling engine 130, including any models that take the received data as input, and any downstream models that use output of a reevaluating model as input, or further input, for an evaluation.

For instance, if a new call is taken at a call center of an implementing organization, all models/modules of modeling engine 130 that take input from all data channels may execute using or including the newly received data from the client call to the call center. Additionally, any models that use the output of models that execute based on incoming data from all data channels (i.e., that have output dependencies on other models' output) may also be triggered. For example, since a new sentiment score will be produced for the newly received call information, execution of an updated analysis by health scorer 138 may be triggered, so that the new sentiment score may be factored into a most recent client health index score. Moreover, execution of a new evaluation by product predictor 140 may be triggered in order to factor in a freshly generated client health index score into a newly generated attrition score. Models/modules of modeling engine 130 that include output dependencies on the output from other models include health scorer 138, product predictor 140, churn predictor 146, and lead scorer 152 (each as described, above).

In accordance with aspects, data from insight store 160 and from preprocessed data 124 may be used to periodically re-train models included in modeling engine 130. As the data is updated and verified based on use of the platform, retraining of the models based on the updated and validated data may make predictions from retrained models more accurate.

In accordance with aspects, data from insight store 160 may be queried using a client identifier as a lookup key and may be sent to an interface (not shown in FIG. 1) for use by employees of an implementing organization. Data from insight store 160 may be formatted in a structured and consumable manner and may be displayed or otherwise made available to employees of an implementing organization for use with interactions with associated clients.

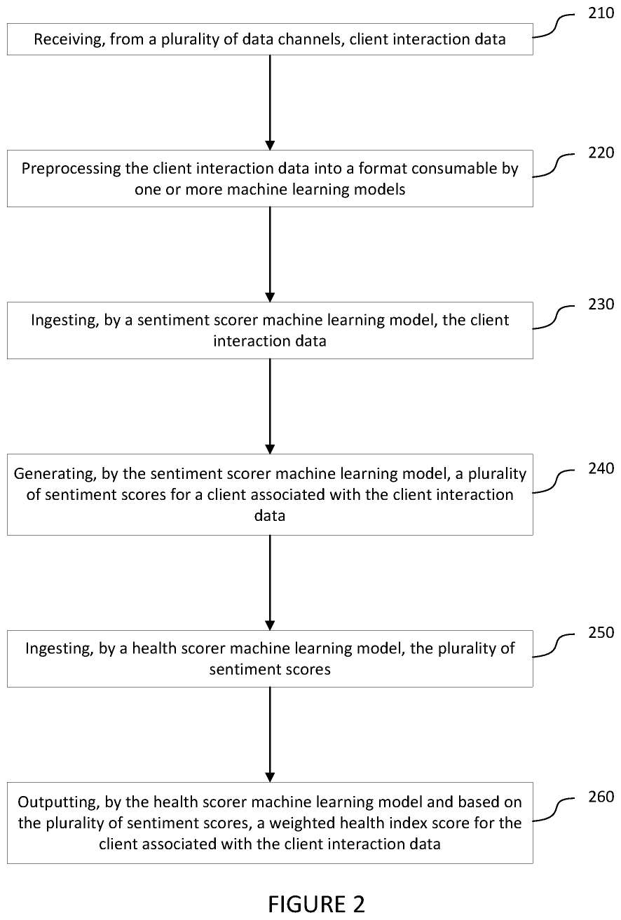

FIG. 2 is a logical flow for modeling of omnichannel data, in accordance with aspects.

Step 210 includes receiving, from a plurality of data channels, client interaction data.

Step 220 includes preprocessing the client interaction data into a format consumable by one or more machine learning models.

Step 230 includes ingesting, by a sentiment scorer machine learning model, the client interaction data.

Step 240 includes generating, by the sentiment scorer machine learning model, a plurality of sentiment scores for a client associated with the client interaction data.

Step 250 includes ingesting, by a health scorer machine learning model, the plurality of sentiment scores.

Step 260 includes outputting, by the health scorer machine learning model and based on the plurality of sentiment scores, a weighted health index score for the client associated with the client interaction data.

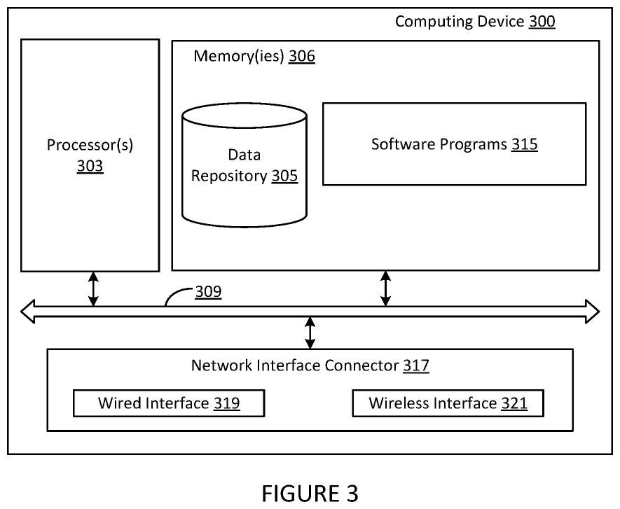

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as preprocessing modules, a modeling engine, ML modules and models, an interface, various database engines and database servers, data stores, data lakes, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” a “computer,” an “electronic device,” a “mobile device,” etc. These may be a computer, a computer server, a host machine, etc. As used herein, the term “processing machine,” “computing device, “computer,” “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above, including any logical stops or logical flows described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, from a plurality of data channels, client interaction data;
preprocessing the client interaction data into a format consumable by one or more machine learning models;
ingesting, by a sentiment scorer machine learning model, the client interaction data;
generating, by the sentiment scorer machine learning model, a plurality of sentiment scores for a client associated with the client interaction data;
ingesting, by a health scorer machine learning model, the plurality of sentiment scores; and
outputting, by the health scorer machine learning model and based on the plurality of sentiment scores, a weighted health index score for the client associated with the client interaction data.

2. The method of claim 1, comprising:
Ingesting, by the health scorer machine learning model, a data channel identifier for each sentiment score of the plurality of sentiment scores, wherein the data channel identifier indicates a data channel from which sentiment data that a corresponding one of the plurality of sentiment scores is based on was received.

3. The method of claim 2, comprising:
Ingesting, by the health scorer machine learning model, an age for each sentiment score of the plurality of sentiment scores, wherein the age indicates a time when the sentiment data that a corresponding one of the plurality of sentiment scores is based on was collected.

4. The method of claim 3, comprising:
providing, for each data channel identifier, a legitimacy score, wherein the legitimacy score indicates a weight assigned to the data channel identifier.

5. The method of claim 4, comprising:
providing a plurality of age weights, wherein each of the plurality of age weights corresponds to a corresponding age window of a plurality of age windows.

6. The method of claim 4, wherein the age for each sentiment score of the plurality of sentiment scores falls into one of the plurality of age windows, and wherein the age for each sentiment score of the plurality of sentiment scores is assigned an age weight that corresponds to the corresponding age window into which each sentiment score of the plurality of sentiment scores falls.

7. The method of claim 6, comprising:
weighting, by the health scorer machine learning model, the weighted health index score based on the age weight that corresponds to the corresponding age window into which each sentiment score of the plurality of sentiment scores falls and the legitimacy score for each data channel identifier for each sentiment score of the plurality of sentiment scores.

8. A system comprising at least one computer including a processor, wherein the at least one computer is configured to:
receive, from a plurality of data channels, client interaction data;
preprocess the client interaction data into a format consumable by one or more machine learning models;
ingest, by a sentiment scorer machine learning model, the client interaction data;
generate, by the sentiment scorer machine learning model, a plurality of sentiment scores for a client associated with the client interaction data;
ingest, by a health scorer machine learning model, the plurality of sentiment scores; and
output, by the health scorer machine learning model and based on the plurality of sentiment scores, a weighted health index score for the client associated with the client interaction data.

9. The system of claim 8, wherein the at least one computer is configured to:
Ingest, by the health scorer machine learning model, a data channel identifier for each sentiment score of the plurality of sentiment scores, wherein the data channel identifier indicates a data channel from which sentiment data that a corresponding one of the plurality of sentiment scores is based on was received.

10. The system of claim 9, wherein the at least one computer is configured to:
Ingest, by the health scorer machine learning model, an age for each sentiment score of the plurality of sentiment scores, wherein the age indicates a time when the sentiment data that a corresponding one of the plurality of sentiment scores is based on was collected.

11. The system of claim 10, wherein the at least one computer is configured to:
provide, for each data channel identifier, a legitimacy score, wherein the legitimacy score indicates a weight assigned to the data channel identifier.

12. The system of claim 11, wherein the at least one computer is configured to:
provide a plurality of age weights, wherein each of the plurality of age weights corresponds to a corresponding age window of a plurality of age windows.

13. The system of claim 11, wherein the age for each sentiment score of the plurality of sentiment scores falls into one of the plurality of age windows, and wherein the age for each sentiment score of the plurality of sentiment scores is assigned an age weight that corresponds to the corresponding age window into which each sentiment score of the plurality of sentiment scores falls.

14. The system of claim 13, wherein the at least one computer is configured to:
weight, by the health scorer machine learning model, the weighted health index score based on the age weight that corresponds to the corresponding age window into which each sentiment score of the plurality of sentiment scores falls and the legitimacy score for each data channel identifier for each sentiment score of the plurality of sentiment scores.

15. A non-transitory computer readable storage medium, including instructions stored thereon, which instructions, when read and executed by one or more computer processors, cause the one or more computer processors to perform steps comprising:
receiving, from a plurality of data channels, client interaction data;
preprocessing the client interaction data into a format consumable by one or more machine learning models;
ingesting, by a sentiment scorer machine learning model, the client interaction data;
generating, by the sentiment scorer machine learning model, a plurality of sentiment scores for a client associated with the client interaction data;
ingesting, by a health scorer machine learning model, the plurality of sentiment scores; and
outputting, by the health scorer machine learning model and based on the plurality of sentiment scores, a weighted health index score for the client associated with the client interaction data.

16. The non-transitory computer readable storage medium of claim 15, comprising:
ingesting by the health scorer machine learning model a data channel identifier for each sentiment score of the plurality of sentiment scores, wherein the data channel identifier indicates a data channel from which sentiment data that a corresponding one of the plurality of sentiment scores is based on was received.

17. The non-transitory computer readable storage medium of claim 16, comprising:
ingesting by the health scorer machine learning model an age for each sentiment score of the plurality of sentiment scores, wherein the age indicates a time when the sentiment data that a corresponding one of the plurality of sentiment scores is based on was collected.

18. The non-transitory computer readable storage medium of claim 17, comprising:
providing, for each data channel identifier, a legitimacy score, wherein the legitimacy score indicates a weight assigned to the data channel identifier.

19. The non-transitory computer readable storage medium of claim 18, comprising:
providing a plurality of age weights, wherein each of the plurality of age weights corresponds to a corresponding age window of a plurality of age windows.

20. The non-transitory computer readable storage medium of claim 18, wherein the age for each sentiment score of the plurality of sentiment scores falls into one of the plurality of age windows, and wherein the age for each sentiment score of the plurality of sentiment scores is assigned an age weight that corresponds to the corresponding age window into which each sentiment score of the plurality of sentiment scores falls, and comprising:
weighting, by the health scorer machine learning model, the weighted health index score based on the age weight that corresponds to the corresponding age window into which each sentiment score of the plurality of sentiment scores falls and the legitimacy score for each data channel identifier for each sentiment score of the plurality of sentiment scores.
